(19) United States
(12) Patent Application Publication
(10) Pub. No.: US 2009/0134990 A1
(43) Pub. Date: May 28, 2009

(54) Compact tire pressure monitoring system via innovative mechanical pressure switch design

(76) Inventors: James Y. Yang, Cupertino, CA (US); Yunlong Min, Nanchang (CN); Jianyun Yang, Nanchang (CN); Qiang Shen, Nanchang (CN); Huigang Tu, Nanchang (CN)

Correspondence Address: Bo-In Lin, 13445 Mandoli Drive, Los Altos Hills, CA, 94022, US

(21) Appl. No.: 11/891,711

(22) Filed: Nov. 23, 2007

(51) Int. Cl. B60C 23/02; B60C 23/00

(52) U.S. Cl. 340/442; 340/447

(57) ABSTRACT

A tire pressure-monitoring (TPM) system includes a TPM device directly mounted onto an air-pumping inlet on a tire. The TPM device further includes a mechanical triggering mechanism engaged to an air pressure through the air-pumping inlet pushing from an air filled in the tire. The triggering mechanism is triggered by a low tire pressure to turn on a micro-controller unit of the TPS device to send a radio frequency (RF) signal for warning a low tire-pressure of the tire. The tire pressure monitoring (TPS) system further includes a signal receiving system near a vehicle driver for receiving and processing the RF signal.

### BACKGROUND OF THE INVENTION

1. Field of the Invention

The present invention is generally related to device configuration and method of a tire pressure-sensing (TPS) and low-pressure warning system. More particularly, this invention is related to system configuration and mechanical pressure switch design for implementing a compact tire pressure monitoring system.

2. Description of the Related Art

Conventional technologies and devices for measuring the changes of tire pressure are still faced with the difficulties that the signals of tire pressure measurements can only transmit to a limited distance and furthermore, the tire pressure measurement devices do not effective antitheft mechanisms.

Generally there are two types of tire pressure monitoring systems (TPMS). The first type of TPMS is an indirect tire pressure monitoring system that monitoring the changes of tire pressures by monitoring the rotational speed differences as that detected and transmitted through the ABS speed transmitter. This type of TPMS has a limitation that the tire pressure monitoring operation would become ineffective when there are simultaneous tire-pressure changes occur in more than one tires. Also, the TPMS become unreliable when a vehicle is traveling at a speed more than one hundred kilometers per hour. A second type of tire pressure monitor system is a direct tire pressure monitoring system implemented with tire pressure measurement devices directly mounted on the tire. The tire pressures are measured and monitored continuously. Once the tire pressure in a tire is lower or higher than a threshold value, an alarm signal is generated. The direct type of TPMS has definite advantages of higher accuracy and reliability over the indirect type of TPMS. However, a discussed above, the direct TPMS devices still have limit capability to effectively transmit pressure monitoring signals and furthermore, there still lacks an antitheft device mechanism with the tire pressure monitoring devices directly mounted onto the tires. Practical application of the direct TPMS devices would still have the concerns that such devices may often be stolen and lost due to such limitations.

Therefore, there is still need to design and manufacture a tire pressure monitor device and system that would enable those of ordinary skill in the art to overcome such difficulties and limitations.

### SUMMARY OF THE INVENTION

Accordingly, it is an aspect of the present invention to provide a tire-pressure monitoring system (TPMS) that includes a tire pressure signal transmission system that is automatically activated only when a tire pressure is lower than a threshold voltage to transmit a low tire pressure signal to a receiver such that the battery power of the TPMS of a sensing and signal transmitting system directly mounted on the tires can be preserved for long term operation.

It is another aspect of this invention that the present invention provides a tire-pressure monitoring system (TPMS) that has an improved accuracy in detecting a low-pressure condition to transmit a warning signal such that the low-pressure condition can be accurately detected and timely corrected.

It is another aspect of this invention that the present invention provides a tire-pressure monitoring system (TPMS) that has a low battery-power detection and reporting capability to send a warning signal to the user of the TPMS to alert the use that the battery power is low. The user of the TPMS system therefore can timely change the battery to maintain the battery power above a low battery power threshold and to continuously keep the TMPS in a good working condition.

It is another aspect of this invention that the present invention provides a tire-pressure monitoring system (TPMS) that has a periodical signal transmission function. A signal transmission system mounted on each tire with tire pressure detection function is programmed to send a periodical signal to a signal receiving system mounted in the main panel near a driver. The user of the TPMS system is therefore kept informed about the operational condition of the tire-pressure monitor function when the periodical signals are received from each tire pressure monitoring devices mounted on the tires.

Specifically, this invention discloses a method for monitoring a tire pressure of a tire on a car. The method includes a step of mounting a tire-pressure monitoring (TPM) device directly onto an air-pumping inlet on a tire. The method further includes a step of mechanically triggering a switch-on of a micro controller unit (MCU) of the TPM device to send an RF signal for warning a low tire-pressure of the tire when a tire-pressure of said tire is lower than a threshold tire-pressure.

These and other objects, features and advantages of the present invention will no doubt become apparent to those skilled in the art after reading the following detailed description of the preferred embodiments that are illustrated in the several accompanying drawings.

### BRIEF DESCRIPTIONS OF THE DRAWINGS

The present invention can be better understood with reference to the following drawings. The components within the drawings are not necessarily to scale relative to each other, emphasis instead being placed upon clearly illustrating the principles of the present invention.

FIG. 1 is a functional block diagram of a tire-pressure signal transmission system of this invention.

FIG. 2 is a circuit diagram of the tire-pressure signal transmission system of FIG. 1.

FIG. 3 is a functional block diagram of a tire-pressure signal receiver system of this invention.

FIG. 4 is a circuit diagram of an RF signal receiver implemented in the tire-pressure signal receiver system of FIG. 3.

FIG. 5 is a circuit diagram of the MCU signal processor implemented in the tire-pressure signal receiver system of FIG. 3.

FIG. 6 is a circuit diagram of a signal display device implemented in the tire pressure signal receiver system of FIG. 3.

FIG. 7 is a diagram for showing the detail structural configuration of the tire pressure-monitoring device as an exemplary embodiment of this invention.

### DETAILED DESCRIPTION OF THE PREFERRED EMBODIMENTS

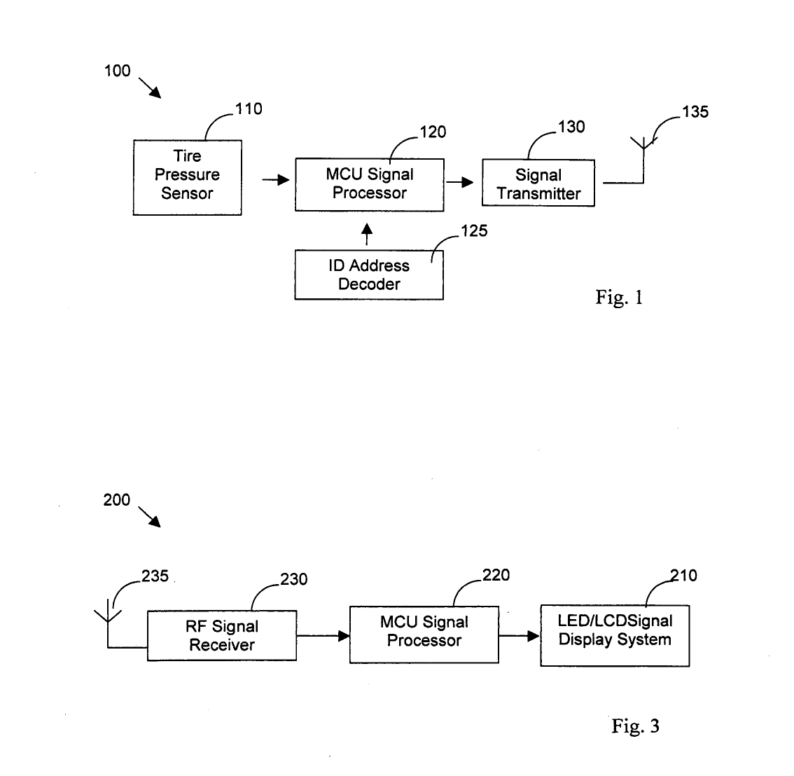

The tire pressure monitoring system of this invention is a direct tire pressure-monitor system with a tire pressure sensor installed as part of a tire pressure sensing-signal transmission system that is mounted directly on each tire. The tire pressure monitoring system continuously monitors the pressure in each fire and the tire pressure sensing-signal transmission system is activated to transmit a “tire pressure low” warning signal when a low-pressure threshold is reached in anyone of the tires of a vehicle. Referring to FIG. 1 for a functional block diagram of a tire pressure sensor (TPS) signal transmission system 100 of this invention. The TPS signal transmission system includes a tire pressure-sensing device 110 that includes an oscillator for providing tire pressure-sensing signal with a specific frequency to a micro-controller unit (MCU processor 120) that carries out all the functions of signal processing and control. The MCU signal processing and control processor 120 further receives signals from an ID address encoder 125 to generate a tire pressure-monitoring signal for inputting to a signal transmitter 130 to transmit the signals to a receiver through an antenna 135.

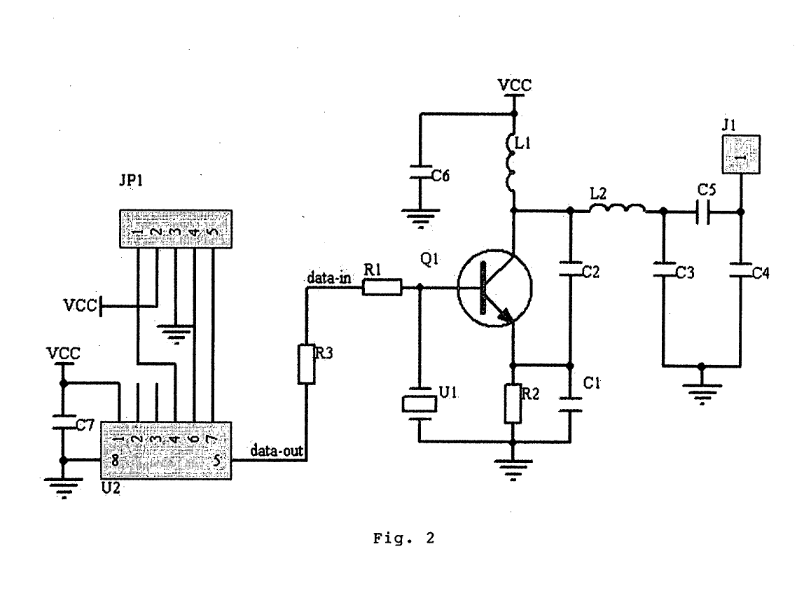

FIG. 2 is a diagram for showing the circuit configuration of the signal transmission system 100. The signal transmission system is operated with a low voltage of three volts thus consumes only small amount of electrical energy during the operation. The signal transmission system 100 includes a chip U2 as a microprocessor to perform all the functions a MCU signal processor 120, i.e., a micro controller unit. An input port JP1 is connected to the MCU signal processor chip U1 to write the ID specifically for a particular user. Another microprocessor chip U1 is a surface acoustic oscillator and Q1 as a transistor to function as a high frequency oscillating circuit. The signal transmission system 100 includes the MCU signal processor 120 is turned when the tire pressure sensing device 110 detects a low tire pressure lower than a threshold tire pressure. The low-pressure signal processed by the MCU signal processor U1 is transmitted through resistor R3 and R1 to the high frequency oscillating transistor Q1 with the transistor Q1 functions with an inductor L1, a capacitors C1 and C2 as a three-point capacitor-type oscillator. The capacitor C6 connecting to the high voltage Vcc to perform a filtering function for the oscillator while capacitor C7 also connected to the high voltage Vcc to perform a filtering function for the MCU microprocessor U1. The capacitors C3 a C4 combined with the inductor L2 forms a π shaped network and coupled through the capacitor C5 to filter out the DC components of the signal to work with the antenna J1.

In a specific exemplary embodiment, the antenna J1 is provided to transmit signals of a frequency at approximately 433.92 MHZ. The signal transmission is carried out during a time when the tire is making a continuously rotational movement. In an exemplary embodiment, the antenna is formed as a screw-shaped antenna taking into consideration of the rotational movement thus generating blind spots due to the dynamic changes of the antenna's locations. However, even there are blind spots of signal transmission projected from the antenna that is rotating with the tire when the vehicle is moving, sufficient intensity of signals are received by a signal receiver to provide low pressure warning signals to a driver when a low pressure condition is detected by the tire-pressure sensing device.

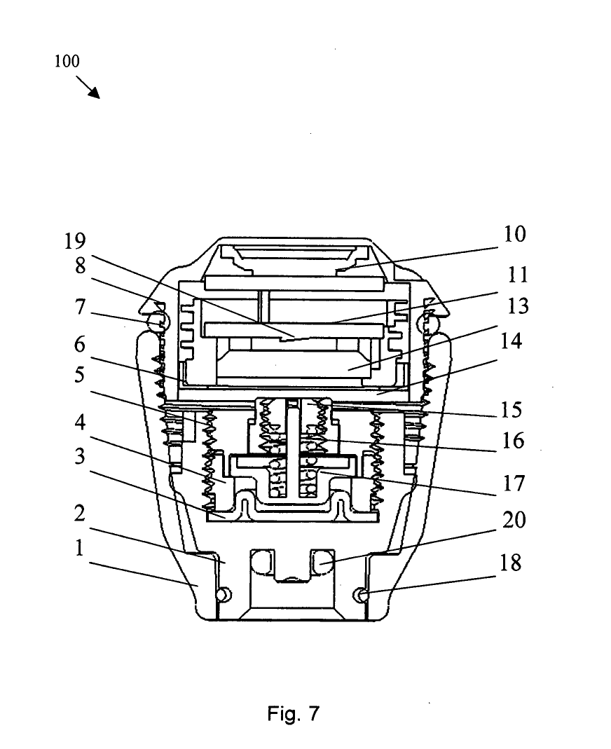

Referring to FIG. 2 again, wherein the microprocessor U2 combines with the capacitor C7 and the input terminal JP1 carries out the functions of the micro-controller unit (MCU). The capacitor C7 functions as a filtering capacitor and JP1 is an input port for receiving the ID-address from the encoder 125. A battery provides power to the microprocessor U2 with a negative potential electrode of the battery 13 connected to the ground terminal of the capacitor C7 and a positive terminal of the battery 13 connected to an opposite terminal of the capacitor C7 as a power source for providing power to the microprocessor U2. The connection of the positive terminal of the battery 13 to the capacitor C7 is from the opposite side of the signal transmitting system shown in FIG. 7. As the tire pressure drops below a threshold, the switch to the battery is turned on and the MCU starts the functions of detecting the voltage of the battery and also sends a low tire pressure warning signal that includes an TPS ID-address for identifying the tire-pressure monitoring signal transmission system to the signal receiving system. The circuit components

R3, R1, Q1, U1, L1, R2, C6, C1, C2, C3, L2, C4, C5 and the antenna function as signal processing functional circuitry. The microprocessor U1 performs a function of a surface acoustic wave oscillator to provide a basic RF frequency for carrying out the function of signal transmission. The combined circuits of Q1 and R3, R1, Q1, L1, R2, C1, C2 function as a waveform amplifier to amplify the signal received from the MCU. The amplified signals are then filtered through the filtering circuit comprised of C3, L2, C4, C5 for transmitting through the antenna.

According to the circuit diagram shown in FIG. 2 above, the signal transmission system 100 as that implemented in the tire-pressure monitoring system (TPMS) of this invention has a low battery-power detection and reporting capability to send a warning signal to the user of the TPMS to alert the use that the battery power is low. A microcontroller unit (MCU) U2 performs a function of checking the voltage of the battery. A battery low-voltage warning signal is generated by U2 when output voltage of a battery is lower than a threshold voltage. The user of the TPMS system therefore can timely change the battery to maintain the battery power above a low battery power threshold and to continuously keep the TMPS in a good working condition.

According to above circuit diagram it is another aspect of this invention that the present invention provides a tire-pressure monitoring system (TPMS) that has a periodical signal transmission function. A signal transmission system mounted on each tire with tire pressure detection function is programmed to send a periodical signal to a signal receiving system mounted in the main panel near a driver. The user of the TPMS system is therefore kept informed about the operational condition of the tire-pressure monitor function when the periodical signals are received from each tire pressure monitoring devices mounted on the tires. Specifically, the signal transmission system of FIG. 2 includes a microprocessor U2 that functions as a micro-controller unit (MCU) to periodically send a signal to a signal receiver mounted inside the car. The signal includes data to indicate whether the tire is operated within a normal tire pressure range and the output voltage of the battery. The signal generated by the U2 as a micro-controller unit (MCU) is transmitted through R3, R1, Q1, L2, and C5 to the antenna for transmitting to the signal receiving system mounted inside the car. A driver of the vehicle is therefore informed of the operational condition of the signal transmission system mounted on each tire.

Another aspect of this invention is the assignment of a unique ID to each tire pressure signal transmitting system 100. A specific ID identified with an “ID-address” is coded by the use of an ID address encoder 125 and the ID-address generated by the ID address encoder 125 is inputted to the MCU 120 through an ID-address input port JP1 and stored into an EPROM (Erasable Programmable Read Only Memory) of the controller U2. The encoded ID address once stored in the EPROM of the controller U2 is programmed into a firmware for transmitting output signal to include this ID-address in the outgoing signals transmitted from the TPS signal transmitting signals. The signal transmitted from each TPS signal transmitting system 100 is transmitted with a header that includes the ID-address of a specific TPS signal transmitting system mounted on a specific tire. The tire pressure signal receiving system once receives a signal from a specific TPS signal transmitting system 100 is able to identify a specific TPS signal transmitting system mounted on a specific tire by using this unique ID address that identifies this TPS signal transmitting system 100.

Referring to FIG. 3 for a functional block diagram of a tire pressure signal receiver system 200 of this invention. The tire pressure signal receiver system includes an antenna 235 to receive the tire pressure signals sent from the tire pressure signal transmission system 100. The tire pressure signals received through the antenna 235 is then sent to an RF signal receiver 230 and processed by a MCU signal processor 220. Then the signal processed and outputted from the MCU signal processor are display in a LED or LCD signal display system 210.

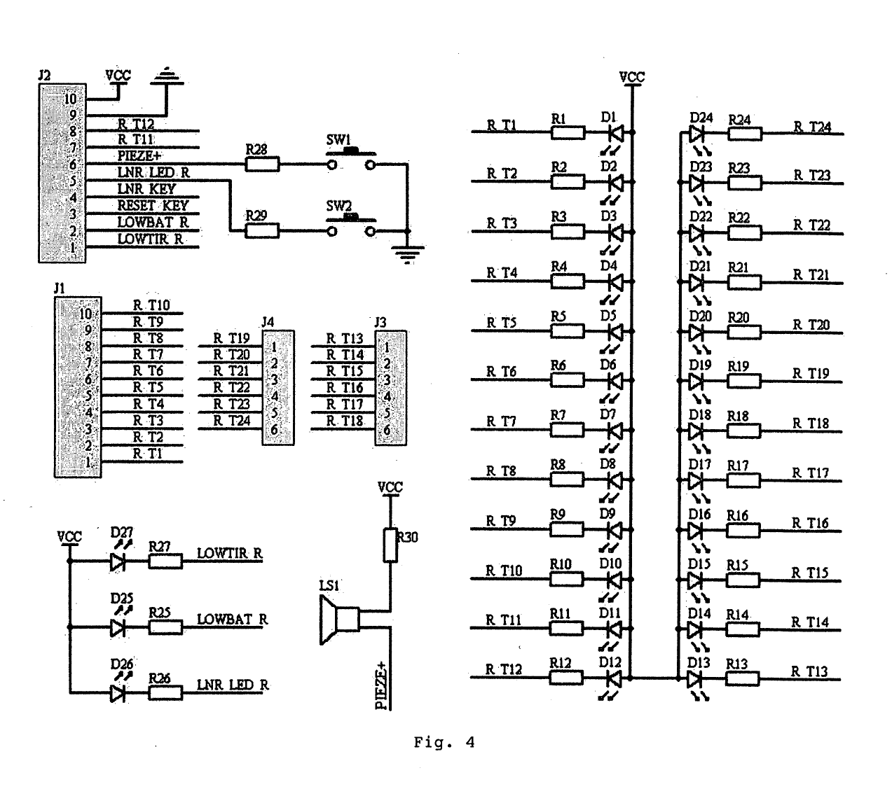

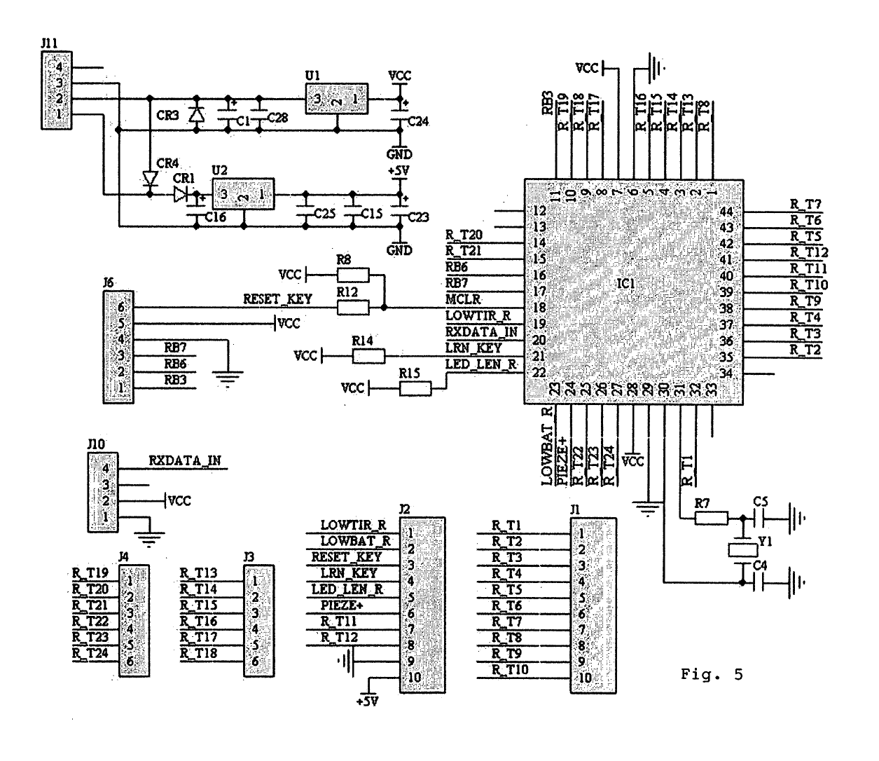

FIG. 4 is a circuit diagram of the RF signal receiver 230 that receives the tire pressure signals through the antenna 235 connected to the circuit implemented as an Integrated circuit as shown. The second leg of the surface acoustic filter F1 and the fifth leg of the filter F1 are respectively the input and the out terminals. The first and the sixth legs of the filter F1 are connected to a ground potential. A crystal oscillator X2 is connected to the filter F1 and the 26^{th} leg of the transistor U3. The third, fourth, seventh and eighth legs of the filter F1 are connected to ground with resistor R3 and capacitor C7 connected in series between the third leg of the filter F1 and the 29^{th} leg of the receiver chip U1. The inductor L2 and the capacitor C6 are connected in series between the fifth leg of the filter F1 and the thirty-first leg of the filter F1 and the thirty-first leg of the chip U3. The inductor L1 and the capacitor C5 are connected in series between the second and the eighth legs of the filter F1 for transmitting a signal outputted from the fifth leg of the filter F1 to the thirty-first leg of the chip U1. The first, fifth, tenth, twenty-second and the second leg of the chip U3 are connected to the ground while the eighth, seventeenth, twenty-seventh and thirty-second legs of the U3 chip are connected to VDD. The twenty-eighth leg is connected to the twenty-seventh leg of the chip U3. The capacitors C10, C11, C12 and C13 are connected in series between the fourth and the seventh legs of the chip U3 and the inductor L3 is connected in parallel to both sides of the capacitor C10. The resistor R18 and R19 are connected respectively to the sixth and the seventh legs of the chip U3 with a common node connected to a voltage VDD. The capacitor C8 and C9 are connected across the thirty, twenty-seventh and the thirty-second legs of the chip U3. A mid-frequency filter F2 includes a first and third legs connected across the eleventh and the ninth legs for inputting a mid-frequency from the chip U1. Capacitors C14, 15, and 16 are connected to the twelfth and the thirteen legs of the chip U3. The resistor R20 is connected across between the twelfth and the thirteen legs and the eleventh and the thirteen legs of the chip U3. The common node of the capacitors C15 and C16 and the second leg of the filter F2 are connected to the ground. The capacitor C19 and C20 are connected in series to the seventeenth and the fourteenth legs of the chip U3. The eighteenth, nineteenth, and twentieth legs are amplification terminals and the nineteenth and the twentieth legs are connected to capacitors C17 and C18 respectively. A resistor R22 is connected across the capacitors C17 and C18. The common node between the capacitors C17 and C18 is connected to the ground. The eighteenth leg of the chip U3 provides an output terminal of an amplified signal. The amplified signals are transmitted through the eighteenth leg to the controller of the receiver chip.

More specifically, the circuit shown in FIG. 4 is to provide a signal interface to the display device to carry out the functions of a graphic user interface. The switch SW1 and SW2 are two reset buttons for providing a learning function. The resistors R28 and R29 are current limiting resistors. LS1 is an alarming device and R50 is a current limiting resistor for the LS1 device. A combination of D25, D26 and D26 is to carry out a function of providing a low-battery power warning display through a LED light and the resistors R25, R26 and R27 are current-limiting resistors. The diodes D1 to D24 are connected to 24 LEDs for indicating the functional conditions of the tire pressure-monitoring signal transmitting systems and the resistors R1-R24 are the corresponding current-limiting resistors. The circuit J1, 2, J4, and J5 are provided to receive and process the signals from the MCU for displaying the signals through the graphic user interface.

Referring to FIG. 5 for a circuit diagram of the MCU signal process 220. The voltage supply receives a twelve volts voltage input to a three-leg voltage stabilizer U1 and through capacitor C1, C2, C3, and C4 and also a diode D10 to covert to a five volts Vcc voltage supply. The tire pressure signals are received and sent to RA4 terminal to output an audio warning signal from the RA5 terminal and a low-pressure warning signal is outputted from a RA0 terminal. A battery-low warning signal is outputted from the RZ1 terminal. RC0 to RC5 terminal output the warning signals for the detected signals at corresponding locations. The input from a learning key is inputted through an input terminal RA2 and the twenty-fourth, twenty-seventh and twenty-eighth legs of the chip U2 are connected to the input terminal J2 of an encoder.

Specifically, the FIG. 5 shows the circuits that provide the function of a micro-controller unit (MCU) 220 of the signal receiving system 200 of FIG. 3. The MCU 220 processes the RF signals received and processed by the RF signal receiver 230. The MCU 220 further processes the user interface signals through the push buttons as shown in FIG. 4 to confirm the display and control status as displayed through the LED lights. A microprocessor IC1 is programmed to perform the MCU functions and to work with C4, C5, Y1, and R7 as an oscillator. The IC1 further combines with R8, R12, R14, R15 as another signal processing functional block. The input terminal J6 serves the function of programming the microprocessor IC1 to perform different functions of the MCU 220. The terminals J1, J2, J4, and J5 are connected the corresponding terminals J1, J2, J4, and J5 of the circuits shown in FIG. 4 to monitor and control the signal and status display functions. A DC input voltage of 12 volts is plugged in through the input port J11 to provide power for the display device of the signal receiving system 200. The input voltage is transmitted through CR3, CR4, C1, C28, U1, C24 to provide a high voltage and the terminal J10 is a high voltage output (USART) terminal. The input voltage is processed through CR1, C16, U2, C25, C15, and C23 to provide a low voltage of five volts as power source of the signal receiver.

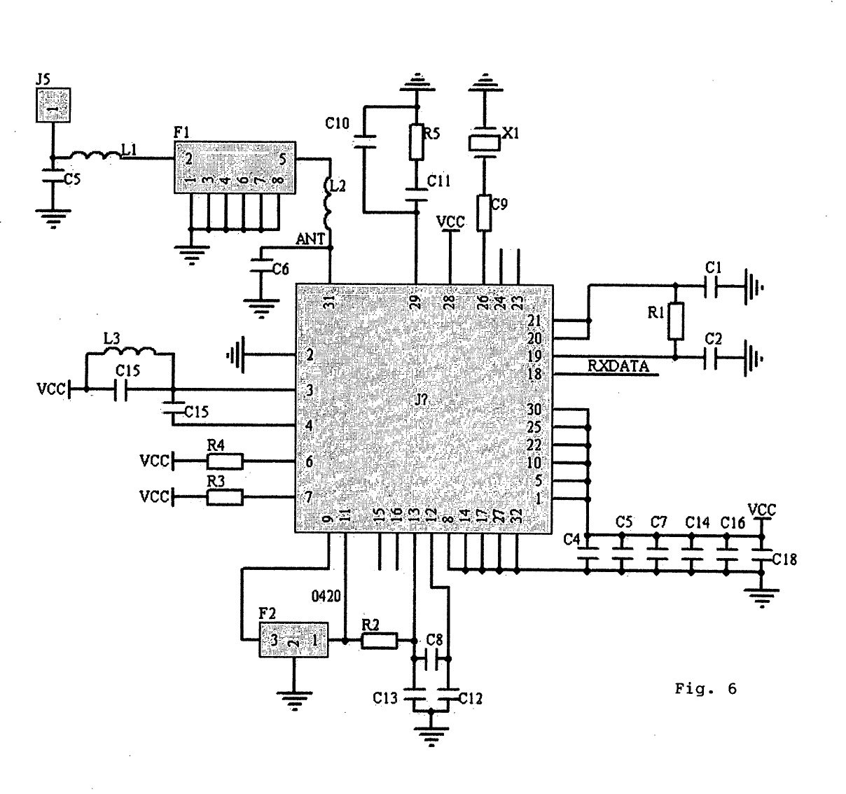

Referring to FIG. 6 for the circuit diagram of the LED or LCD signal display system 210. Corresponding to the location of each tire, the display system 210 includes six light emitting diodes (LED) for each tire. Three LEDs are employed to indicate a condition of low battery power, power supply connectivity, and low tire pressure (D7 to D9). The display system further includes an audio warning device B1, and two buttons SW1 and SW2. Each of the six resistors R1 to R6 are connected in series respectively to each of the six LEDs, D1 to D6, and a common node of the six LEDs is connected to a high voltage terminal VCC. The other ends for each of the six resistors R1 to R6 are connected to a connector J1. The LEDs D7 to D9 are connected to resistors R7 to R9 respectively and the other ends of the resistors R7 to R9 are connected to a common node with a voltage VCC. The audio alarm device B1 is connected directly to a transistor Q1 with another end connected to the ninth leg of the connector J1. The first and the ninth legs of the connector J1 are connected to the ground and VCC respectively and the third leg of the connector J1 is connected to resistor R10 and recovery button SW1, and the fourth leg of the connector J1 is connected to resistor R11, the learning button SW1, and the common ground node of the buttons SW1 and SW2.

In FIG. 6, the signals received from antenna J5 are processed and filtered through C5, L1, F1, and L2 and then processed by microprocessor U1 to amplify, demodulate and compare to generate high and low multi-voltage level signals for transmitting to the MCU 220 for further process as described above.

Referring to FIG. 7 for the detail structural configuration of the tire pressure-monitoring device 100 as an exemplary embodiment of this invention. One electrode of the battery 13 is engaged to and contacting a metallic adjusting screw 15 that in turn is engaged to a spring 16. The other end of the spring 16 pushes onto a bottom of a receiving cup 17 and the receiving cup 17 has a bottom surface pressing onto a pressing ring 4. The pressing ring 4 has a screw interface edge that is screwed onto the base core 2The base core 2 is tightly engage to a copper ring 6 and the cooper ring has a back surface that supports circuits connected to the printed circuit board (PCB) 11. The PCB 11 is connected to another electrode of the battery 13 through a battery spring plate 19. A complete electric current conducting path is therefore formed according to above configuration. In a normal operation condition, a normal tire pressure pushes up the film plate 3 that pushes up the receiving cup 17 thus disconnected the connection of the PCB to the battery to save the battery power in a normal tire pressure condition. When the tire pressure is lower than a threshold, the receiving cup 17 is pushed back by the spring 16 thus contact to the base core 2 and a complete electric current conducting path is formed to the circuit supported on the PCB. Then a low tire pressure signal is transmitted. A pressure adjustment screw 15 carries out a function for adjusting the length of the spring 16. By accurately adjusting the length of the spring 16, the pressure measurements can be more accurately calibrated and pressure drop can be more accurately detected.

With a structural configuration as shown in FIG. 7, the tire pressure-monitoring device 100 further has a waterproof structural feature. The base core 2 is attached securely to a tire pressure-pumping stem and sealed by a ring 20 to prevent water or moisture to enter into the internal space of the tire pressure-monitoring device 100. The front cover assembly 1 is securely attached to the core base 2 and seal with another ring 18 to prevent water or moisture to enter into the internal space of the tire pressure-monitoring device 100. The back cover assembly is screwed onto the front cover assembly 1 through an O-ring that again seal the interface to prevent water or moisture to enter into the internal space of the tire pressure-monitoring device 100.

Furthermore, one aspect of this invention is to enable the tire pressure monitoring system to more accurately detect a low-pressure condition. According to above structural features, improved accuracy for detecting a low-pressure condition is achieved because an elongated rod is placed through the central portion of the receiving cup 17 that penetrates through the pressure measurement adjustment screw 15. The receiving cup 17 is engaged against the pressure measurement adjustment screw 15 instead of floating freely along the central rod. The length of the spring therefore is adjusted immediately with fixed regularity with the change of the tire pressure to accurately detect the tire pressure changes. The inaccuracies that could be induced due to the changes of the position of a freely movable floating receiving cup 17 caused by external vibrations or outside pressures that leads to a variation of the lowest contact position to the pressure cup 4 are therefore eliminated. For these reasons, the accuracy of pressure drop measurements is significantly improved.

Although the present invention has been described in terms of the presently preferred embodiment, it is to be understood that such disclosure is not to be interpreted as limiting. Various alternations and modifications will no doubt become apparent to those skilled in the art after reading the above disclosure. Accordingly, it is intended that the appended claims be interpreted as covering all alternations and modifications as fall within the true spirit and scope of the invention.

We claim:

1. A tire pressure-monitoring (TPM) device directly mounted onto an air-pumping inlet on a tire comprising:
a tire-pressure engaging-plate engaged to an air pressure through said air-pumping inlet pushing from an air filled in said tire; and
a spring pressed by said air pressure through said tire-pressure engaging-plate for mechanically triggering a switch-on of a micro-controller unit (MCU) to send a low pressure warning signal when said air pressure drops below a threshold tire pressure causing said spring to push back said tire-pressure engaging-plate.

2. The tire pressure-monitoring (TPM) device of claim 1 wherein:
said spring pressing onto a receiving cup comprising a conductive metal for contacting a battery as a power source for turning on said TPM device to send said low pressure warning signal when said air pressure drops below a threshold tire pressure causing said spring to push said receiving cup to contact a terminal of said battery.

3. The tire pressure-monitoring (TPM) device of claim 1 further comprising:
a radio frequency (RF) signal generator for generating an RF signal for transmitting said low pressure warning signal.

4. The tire pressure-monitoring (TPM) device of claim 1 further comprising:
a micro-control unit (MCU) for encoding said low pressure signal with a TPM ID-address for identifying said TPM device on a specific tire in sending said low pressure warning signal.

5. The tire pressure-monitoring (TPM) device of claim 1 further comprising:
a micro-control unit (MCU) for periodically sending a TPM device status signal encoded with a TPM ID-address for identifying said TPM device mounted on a specific tire in sending said TPM device status signal for indicating functional status of said TPM device.

6. The tire pressure-monitoring (TPM) device of claim 1 further comprising:
a micro-control unit (MCU) for periodically sending a battery capacity signal encoded with a TPM ID-address for identifying said TPM device mounted on a specific tire in sending said battery capacity signal.

7. The tire pressure-monitoring (TPM) device of claim 1 further comprising:
a micro-control unit (MCU) having a TPM-ID encoding port for entering a TPM-ID address for identifying a TPM device mounted on a specific tire.

8. The tire pressure-monitoring (TPM) device of claim 1 further comprising:
a signal transmission system having a control unit (MCU) for operating at a low voltage at approximately three volts.

9. The tire pressure-monitoring (TPM) device of claim 1 further comprising:
a spring length adjustment mechanism for adjusting a length of said spring for adjusting said threshold tire-pressure for detecting a low pressure tire and mechanically triggering a switch-on of said MCU to send said low pressure warning signal.

10. The tire pressure-monitoring (TPM) device of claim 1 further comprising:
a signal transmission system having an antenna for transmitting a signal of a frequency in a range of approximately 200 to 600 MHz.

11. A tire pressure-monitoring (TPM) system comprising a TPM device directly mounted onto an air-pumping inlet on a tire wherein:
said TPM device further includes a mechanical triggering mechanism engaged to an air pressure through said air-pumping inlet pushing from an air filled in said tire; and
said triggering mechanism is triggered by a low tire pressure to turn on a micro-controller unit of said TPS device to send a radio frequency (RF) signal for warning a low tire-pressure of said tire.

12. The tire pressure-monitoring (TPS) system of claim 11 wherein:
said TPM device further includes a signal transmission system having an antenna for transmitting a signal of a frequency in a range of approximately 200 to 600 MHz.

13. The tire pressure-monitoring (TPS) system of claim 11 further comprising:
a signal receiving system near a vehicle driver for receiving and processing said RF signal.

14. The tire pressure-monitoring (TPS) system of claim 11 further comprising:
a signal receiving system near a vehicle driver for receiving and processing RF signals sent from several TPM devices mounted on multiple tires.

15. The tire pressure-monitoring (TPS) system of claim 11 further comprising:
a signal receiving system having an image display near a vehicle driver for receiving and processing RF signals sent from several TPM devices mounted on multiple fires for displaying an image for viewing by said vehicle driver.

16. The tire pressure-monitoring (TPS) system of claim 11 wherein:
said TPM device further includes a micro-control unit (MCU) for encoding said low pressure signal with a TPM ID-address for identifying said TPM device mounted on a specific tire in sending said radio frequency (RF) signal for warning a low tire-pressure of said tire.

17. The tire pressure-monitoring (TPS) system of claim 11 wherein:
said TPM device further includes a micro-control unit (MCU) for periodically sending a TPM device status signal encoded with a TPM ID-address for identifying said TPM device mounted on a specific tire in sending said TPM device status signal for indicating functional status of said TPM device.

18. The tire pressure-monitoring (TPS) system of claim 11 wherein:
said TPM device further includes a micro-control unit (MCU) for periodically sending a battery capacity signal encoded with a TPM ID-address for identifying said TPM device mounted on a specific tire in sending said battery capacity signal.

19. The tire pressure-monitoring (TPS) system of claim 11 wherein:
said TPM device further includes a micro-control unit (MCU) having a TPM-ID encoding port for entering a TPM-ID address for identifying a TPM device mounted on a specific tire.

20. A method for monitoring a tire pressure of a tire on a car comprising:—monitoring (TPM) system comprising a TPM device directly mounted onto an air-pumping inlet on a tire wherein:
mounting a tire-pressure monitoring (TPM) device directly onto an air-pumping inlet on a tire; and
mechanically triggering a switch-on of a micro controller unit (MCU) of said TPM device to send an RF signal for warning a low tire-pressure of said tire when a tire-pressure of said tire is lower than a threshold tire-pressure.
